(19) United States
(12) Patent Application Publication
(10) Pub. No.: US 2007/0009211 A1
(43) Pub. Date: Jan. 11, 2007

(54) Optical alignment system

(76) Inventors: Jan Peter Karel Van Koetsem, Basel (BE); Henrikus Petru Gijsbertus Van Der Steen, Den Dungen Noord Brabant (NL)

Correspondence Address: HARRINGTON & SMITH, LLP, 4 RESEARCH DRIVE, SHELTON, CT, 06484-6212, US

(21) Appl. No.: 10/567,959

(22) PCT Filed: Aug. 6, 2004
(86) PCT No.: PCT/EP04/51736

§ 371 Date: Sep. 1, 2006

(30) Foreign Application Priority Data
Aug. 14, 2003 (NL) 1024107

(51) Int. Cl. G02B 6/36

(52) U.S. Cl. 385/89; 385/52

(57) ABSTRACT

The invention relates to an optical alignment system including an optical board connector with a ferrule assembly terminating a plurality of optical fibres and a circuit board comprising a cavity for at least one embedded device, said circuit board comprising first positioning elements. The circuit board includes a plate exposing said cavity and having an accurate position with respect to said cavity and said ferrule assembly includes second positioning elements adapted to cooperate with said first positioning elements made available by said plate to align said terminated optical fibres and said embedded device.

The invention relates to an optical alignment system comprising an optical board connector with a ferrule assembly terminating a plurality of optical fibres and a circuit board comprising at least one cavity for an embedded device, said circuit board comprising first positioning elements.

WO 02/061481 discloses an optical connector for use with an electro-optical board. The optical connector comprises a redundant alignment system wherein a female self-alignment body is provided with a tapered channel and a tapered male self-alignment body sized to fit closely into the tapered channel of the female body. Moreover the female body is aligned with the sides of a frustoconical board embedded right angle interface body. This interface body moreover comprises precision alignment holes for alignment pins extending from the male body. Off-board optical fibres terminate in the male body such that optical signals provided over the fibres may be transmitted via a plurality of optical conductors in a right angle interface body with an integrated mirror to and from a plurality of embedded optical fibres in a multi-layer circuit board.

The prior art optical connector is disadvantageous in that the redundant alignment system results in a tolerance stack-up that is detrimental for the performance of the optical system in terms of transmission of optical signals. This tolerance stack-up results from the unavoidable inaccuracies in close fitting of the several bodies of the prior art optical connector.

It is an object of the invention to provide an optical alignment system having a reduced tolerance stack-up.

This object is achieved by providing an optical alignment system characterized in that said circuit board comprises a plate exposing said cavity and having an accurate position with respect to said cavity and said ferrule assembly comprises second positioning elements adapted to cooperate with said first positioning elements made available by said plate to align said terminated optical fibres and said embedded device. The tolerance stack-up here only comprises the position tolerances of the plate to the cavity increased by the tolerance of the connector housing to the plate. Moreover another tolerance stack is provided by the inaccuracies arising from the positioning of the first positioning elements to the embedded device and the first positioning elements to the second positioning elements of the ferrule assembly. Both tolerance stack-ups are less than in the prior art system. It is noted that alternatively the second positioning elements may be provided in another part of the optical board connector.

In an embodiment of the invention the first positioning elements are provided as separate elements on or within said circuit board. The plate may comprise holes adapted to cooperate with said first positioning elements and to position said plate with respect to said cavity. In this embodiment both the plate to cavity and the ferrule assembly to the device are aligned by the first positioning elements.

Alternatively the first positioning elements are provided as alignment pins on the plate itself. In this embodiment the plate must be positioned with respect to the cavity without the aid of the first positioning elements, e.g. with a pick and place machine. However, in this embodiment the alignment pins can be manufactured very accurately with respect to the opening in the plate for exposing the cavity. The alignment pins may protrude within the circuit board to facilitate positioning of the plate with respect to the cavity.

In an embodiment of the invention said plurality of optical fibres constitutes a high density array and said second positioning elements comprise three alignment pins or holes positioned with respect to the centre of said array. Especially for large arrays of optical fibres, misalignment resulting from differences in thermal expansion coefficients of the various components may give rise to unacceptable optical losses. By positioning the second positioning means with respect to the centre of the array of optical fibres, the distance between the second positioning means has no influence on thermal misalignment as the thermal expansion starts from the centre of the array.

In an embodiment of the invention the circuit board comprises a housing for said embedded device adapted to preposition said optical board connector. This housing may be positioned on the plate and employed to fixate the optical board connector to the circuit board.

In an embodiment of the invention the ferrule assembly is movably contained by said optical board connector. This facilitates alignment of the optical fibres with the embedded device.

In an embodiment of the invention the ferrule assembly comprises a ferrule plate protruding from said board connector within said cavity. Such an arrangement provides a small and better controlled gap between the optical fibres and the embedded device as a result of which alignment tolerances have less influence on the optical signal loss.

In an embodiment of the plurality of optical fibres constitutes a two-dimensional array of optical fibres. In such a high-density array control of the alignment of the various parts of the system is particularly relevant. Preferably said ferrule assembly comprises holes for terminating said optical fibres, said holes comprising at least one substantially straight edge. The shapes of these holes enable to combine adequate fixation or delimitation of the optical fibres with ease of manufacturing of these holes resulting in reduced vulnerability of the system for alignment tolerances.

The invention also relates to a ferrule assembly and a plate for use in a system as described above.

The invention further relates to a method for aligning an optical board connector with terminated optical fibres and a circuit board comprising first positioning elements and a cavity for at least one embedded device comprising the steps of:
providing a plate with an opening exposing said embedded device and positioning said plate with respect to said cavity such that said first positioning elements remain available;
positioning said board connector onto said plate and aligning said optical fibres with said embedded device by having second positioning elements of said board connector cooperating with said first positioning elements.

The invention will be further illustrated with reference to the attached drawings, which show a preferred embodiment according to the invention. It will be understood that the invention is not in any way restricted to this specific and preferred embodiment.

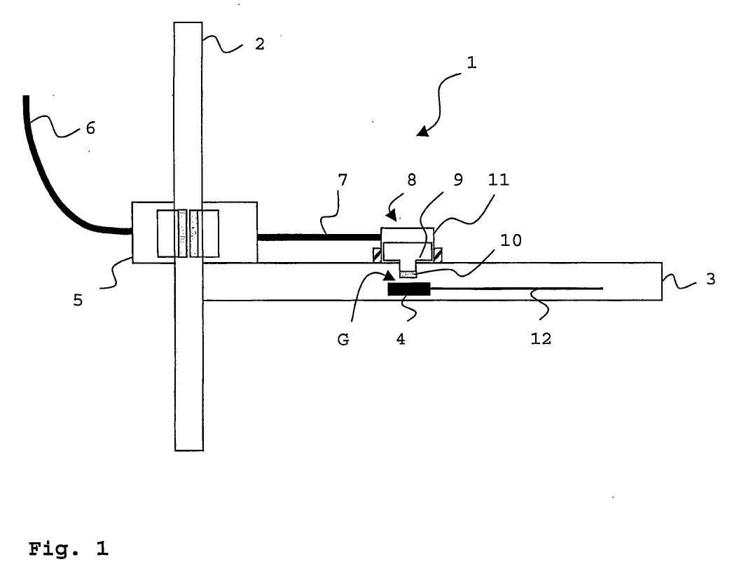

FIG. 1 shows a schematical illustration of an optical backpanel system;

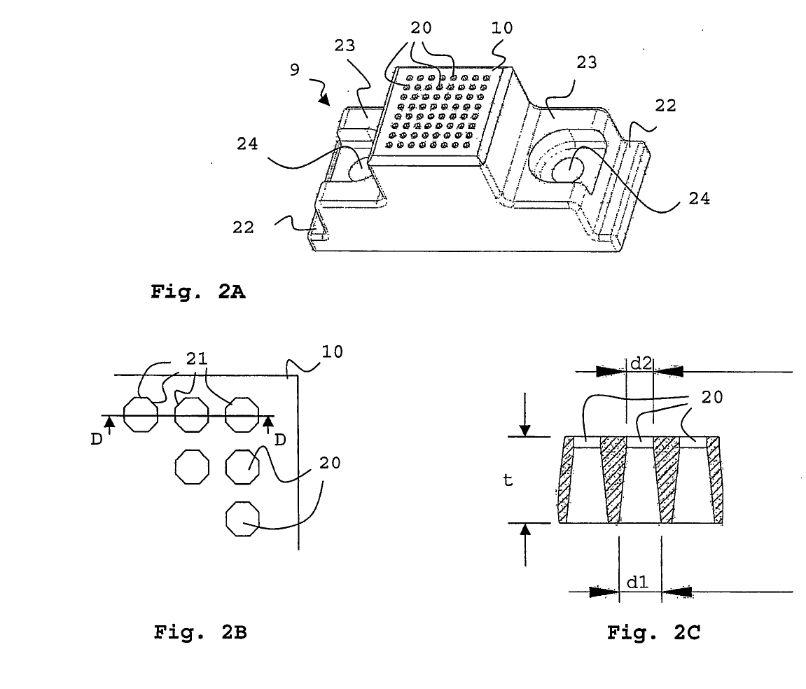

FIGS. 2A-2C show a fibre fixation part according to an embodiment of the invention;

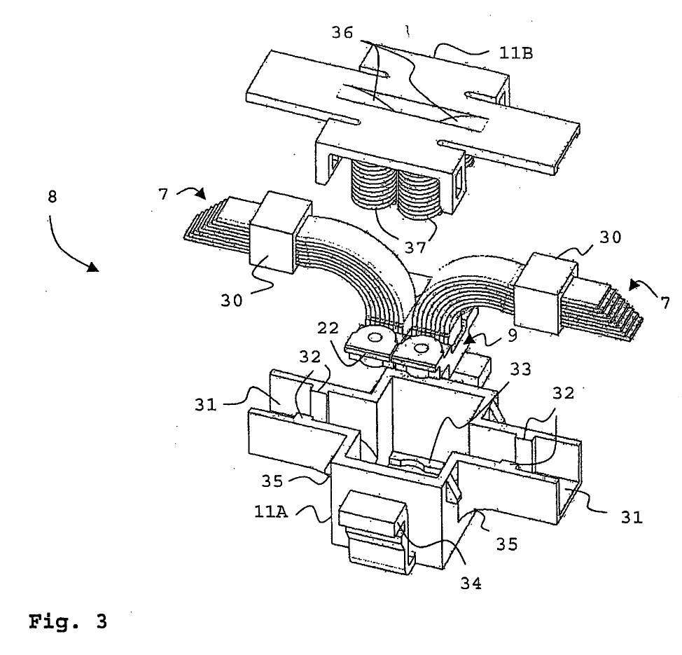

FIG. 3 shows an exploded view of an optical board connector assembly according to an embodiment of the invention;

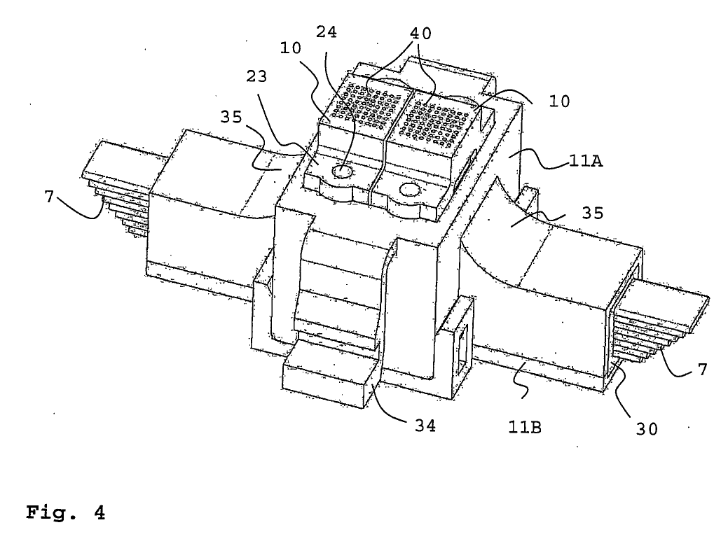

FIG. 4 shows a view of an optical board connector assembly in assembled state according to an embodiment of the invention;

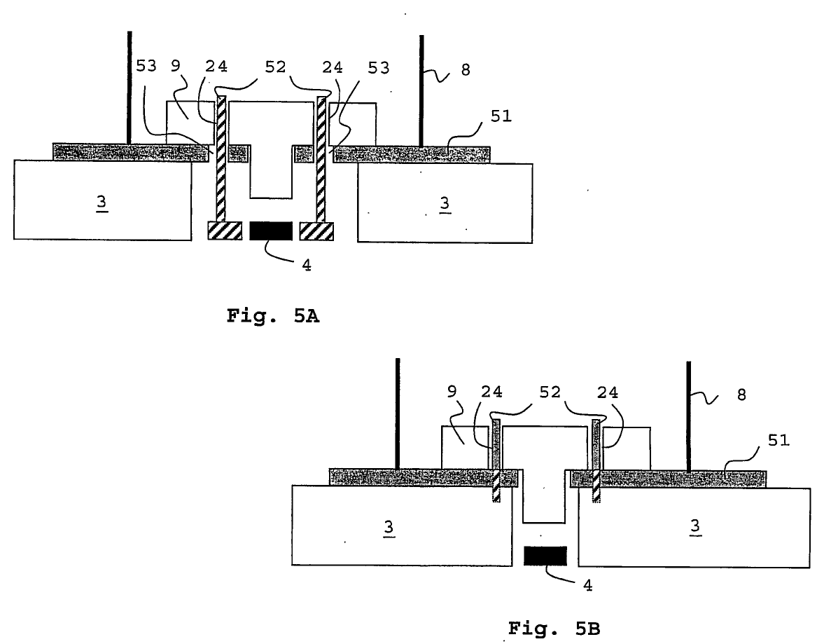

FIGS. 5A and 5B show illustrations of the optical alignment system according to an embodiment of the invention.

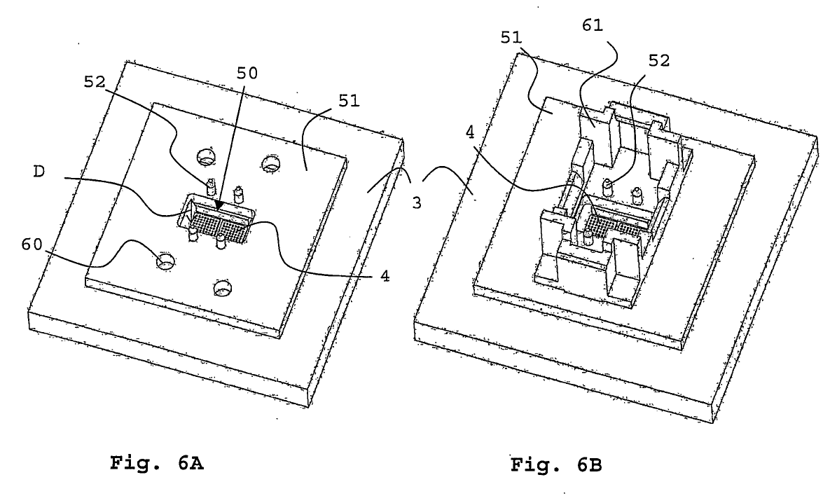

FIG. 6A and 6B show a system card comprising an embedded device;

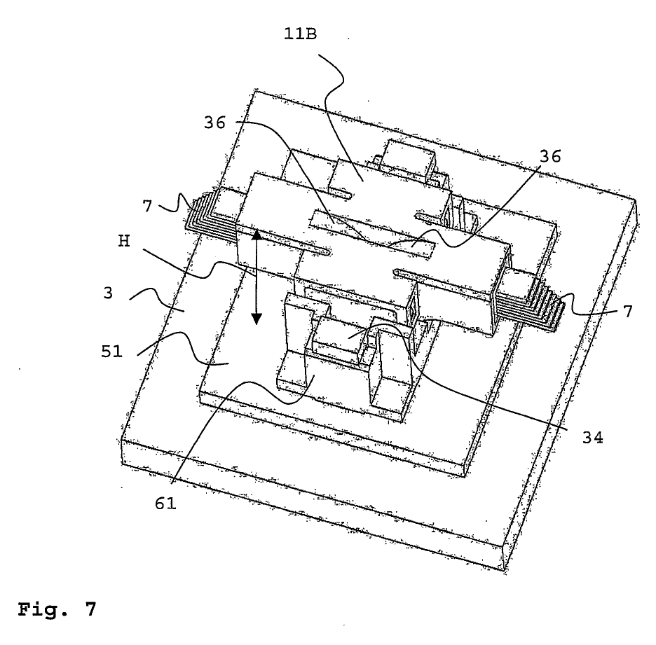

FIG. 7 shows an optical board connector assembly according to the invention optically connected to a board embedded device;

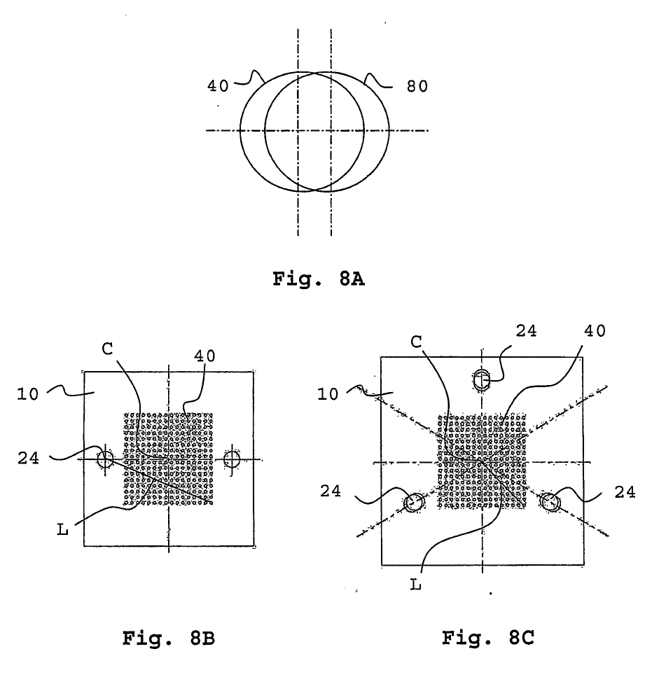

FIGS. 8A-8C illustrate an arrangement for the second position elements according to an embodiment of the invention to cope with thermal misalignment effects.

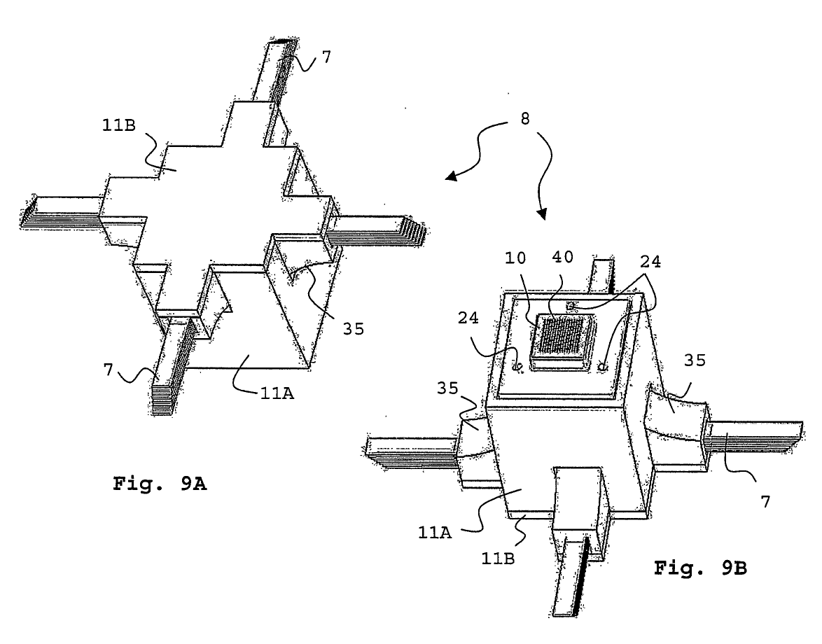

FIGS. 9A and 9B show an alternative embodiment of an optical board connector assembly according to an embodiment of the invention.

In FIG. 1 an optical system 1 is shown comprising a backpanel 2 and a system card or printed circuit board (PCB) 3 with an embedded device 4. The embedded device 4 may e.g. be an active optical or electro-optical component, such as a combination of a vertical cavity surface emitting laser (VCSEL) and a sensor, or a passive component such as a mirror or one or more embedded optical waveguides. A connector assembly 5 optically connects a plurality of optical cables 6 via the off-board optical cables 7 to a surface mounted optical board connector assembly 8. The surface mounted board connector 8 comprises a ferrule assembly with a fibre fixation part or ferrule holder 9 and a ferrule part or ferrule plate 10 protruding from the assembly 8. The fibre fixation part 9 cooperates with housing 11 of the board connector assembly 8 to control the gap G between the surface of the ferrule part 10 and the device 4. The optical cables 6, 7 may comprise a plurality of ribbon cables, each of said cables comprising a plurality of optical fibres. Optical signals may be transferred over those optical fibres to or from the device 4. The device 4 is embedded in the PCB 3 and connected to other components (not shown) via waveguide 12.

FIGS. 2A-2C show various aspects of the ferrule assembly. The fibre fixation part 9 has a step-like shape. The ferrule part 10 is preferably a high-density ceramic plate with two-dimensional array of through-holes 20 for individual optical fibres. The holes 20 comprise substantially straight edges 21, as most clearly visible in FIG. 2B. Preferably the edges 21 of the holes 20 form a polygon, such as an octagon shown in FIG. 2B. The ferrule part 10 is thin, e.g. in a range of t=0.3-0.8 mm, allowing the provision of a large amount of substantially parallel through-holes 20 per unit area. Moreover the holes 20 preferably are tapered, i.e. the dimension d1 at the entrance side for the fibres is larger than the dimension d2 at the fibres stopping side to facilitate insertion of the optical fibres. The dimension d2 is e.g. in the range of 125-128 micron, such as 127 micron, while the pitch, i.e. the distance between adjacent holes 20, is e.g. in the range of 0.15-0.30 mm, e.g. 0.25 mm or 0.2 mm. Such a configuration enables a low loss connection between a large two-dimensional array of optical fibres and a device 4, at least for multimode signals. The fibre fixation part 9 further comprises a support part or lip 22 for maintaining said fibre fixation part 9 in the housing 11 of the optical board connector assembly 8 (shown in FIGS. 3 and 4) and location surfaces 23. Fibre fixation part 9 also includes guidance openings 24 for receiving alignment pins 52 (FIGS. 6A and 6B). The ferrule part 10 is the subject of a co-pending patent application (“Ferrule assembly for optical fibres”) of the applicant of the same date. The features and advantages of the holes 20 and the method for manufacturing these holes, the mould and method for manufacturing such a mould are herewith incorporated by reference. The fibre fixation part 9 comprises an opening (not visible in FIG. 2A) opposite to the ferrule plate 10 to receive, the optical fibres.

FIG. 3 shows an exploded view of an optical board connector assembly 8 according to an embodiment of the invention comprising a housing part 11A and a housing cover 11B. Further FIG. 3 displays a plurality of optical cables 7 bundled by bundle epoxy elements 30 and fixated in two fibre fixation parts 9. It should be appreciated that the optical cable assembly 8 may be suitable for more or less optical cables 7 and more or less fibre fixation parts 9 as e.g. shown in FIGS. 9A and 9B.

The housing part 11A comprises entrances 31 for the optical cables 7. The entrances 31 are provided with internal structures 32 to position and/or hold the bundle epoxy elements 30. Further the housing part 11A comprises a support structure 33 adapted to cooperate with the support parts 22 of the fibre fixation parts 9 to allow the ferrule plate 10 to protrude beyond the housing 11A. The housing part 11A also comprises mounting elements 34 for mounting the housing 11 to the board 3, e.g. by employing the housing 61 of the embedded device 4, as shown in FIG. 7. Further the housing part 11A comprises curved sections 35 to guide the optical cables 7 from the entrances 31 to the holes 20 of the fibre fixation parts 9. The radius of the curved sections 35 may be in the range below 8 mm, e.g. 2 mm especially if the optical fibres are of plastic (POF). Such a small curvature may diminish the total height H (see FIG. 7) of the board connector assembly 8 considerably.

The housing top 11B comprises curved sections 36 and resilient members 37, such as springs. The springs 37 provide z-float functionality to the ferrule assemblies 9 as described in detail in the co-pending application (“Optical board connector assembly”) of the applicant of the same date. The detailed description with regard to the protruding part of the ferrule and the springs is incorporated by reference from this co-pending application. The housing top 11B is sized to fit with the housing part 11A to constitute an appropriate board connector housing 11 for the assembly 8.

FIG. 4 shows a view of the optical board connector assembly 8 of FIG. 3 in an assembled state. Identical reference numerals are used to indicate identical features. Clearly the fibre fixation part 9 with the ferrule part 10 protrudes from the connector housing 11A. The holes 20 (see FIG. 2A) fixate individual optical fibres 40 of the optical cables 7.

Next the operation of the optical alignment system will be illustrated with respect to FIGS. 5A and 5B. The optical alignment system comprises the board connector 8 that is surface mounted on the PCB 3. Alternatively, press fit connection is possible. The board connector 8 has a ferrule assembly 9 terminating a plurality of optical fibres (not shown). The PCB 3 comprises a cavity or opening 50 (FIG. 6A) for the embedded device 4. The PCB 3 is covered with a plate 51 having an opening to expose the embedded device 4. The plate 51 is e.g. of a ceramic material as such a material exhibits a small thermal expansion coefficient. Alternatively the plate 51 may be of a material having a similar thermal expansion coefficient as the PCB 3 or the substrate material of the embedded device 4. The PCB 3 comprises first positioning elements 52. The first positioning elements or alignment pins 52 either are provided in the PCB 3 as separate elements (FIG. 5A) or are part of the plate 51 (FIG. 5B). In FIG. 5A the plate 51 makes the separate alignment pins 52 available by holes 53. The alignments pins 52 may also be integral parts of the plate 51 and protrude from the plate 51 into the PCB 3 (dashed portions in FIG. 5B). The ferrule assembly 9 comprises second positioning elements or holes 24 adapted to cooperate with the alignment pins 52 made available by the plate 51 to align the terminated optical fibres and the embedded device 4. The ferrule assembly 9 is movably mounted within the optical board connector assembly 8 to facilitate alignment. This arrangement provides alignment in the X-Y directions for the embedded device 4, the ferrule assembly 9 and the connector housing 60 without significant tolerance stack ups, because the pins 52 provide location for these parts.

In FIG. 5A first the alignment pins 52 are positioned in the cavity 50 with respect to the device 4. Next the ceramic plate 51 is accurately positioned by fitting the alignment pins 52 in the holes 53. Subsequently the optical board connector 8 is installed by inserting the protruding portion of the ferrule assembly 9 in the cavity 50 such that the holes 24 cooperate with the same alignment pins 52. In this embodiment both the plate 51 to cavity and the ferrule assembly 9 to the device 4 are aligned by the first positioning elements 52.

In FIG. 5B the plate 51 is accurately positioned on the PCB, e.g. by a pick and place machine. In this embodiment the alignment pins 52 can be manufactured very accurately with respect to the opening in the plate 51 for exposing the cavity.

FIGS. 6A and 6B show a practical example of the embodiment of FIG. 6A. A PCB 3 comprises an embedded device 4 that is exposed by a cavity 50. The PCB 3 is covered by the plate 51, e.g. a ceramic plate, that is provided with an opening substantially matching the size of the cavity 50. The distance D between the surface of the ceramic plate 51 and the top of the embedded device 4 is well controlled and measures approximately 1.5 mm. The plate 51 receives the first alignment pins 52 that cooperate with corresponding second positioning elements 24 (not shown). The plate 51 further comprises positioning elements 60 for positioning a housing 61 for the embedded device 4.

In FIG. 7, the optical board connector assembly 8 is connected optically to the board embedded device 4, leaving a gap G (see FIG. 1) between the terminal ends of the optical fibres 40 and the device 4. The gap G preferably is 20 micron and can be controlled with a deviation of e.g. 5 to 10 micron when connecting the housing 11 and housing 61. This mounting is facilitated by employing the mounting elements, such as latches 34, by e.g. snap fitting.

FIGS. 8A-8C illustrate an arrangement for the second position elements 24 according to an embodiment of the invention to cope with thermal misalignment effects. Such effects are especially relevant for large arrays of optical fibres. FIG. 8A schematically displays misalignment between a terminated fibre 40 in the ferrule plate 10 and a corresponding part 80 of the embedded device 4.

In FIG. 8B the high density ferrule plate 10 of the ferrule assembly 9 is shown with optical fibres 40 and two second positioning elements 24. The maximum thermal misalignment is indicated by L and is clearly dependent on the position of the element 24.

In FIG. 8C a different arrangement of second positioning elements 24 is shown, wherein the plurality of optical fibres 40 constitutes a high density array and the second positioning elements 24 comprise three alignment holes 24 positioned with respect to the centre C of the array. By using a third second positioning element 24 misalignment is controlled from the centre C. The distance between the positioning elements 24 is no longer relevant for the influence of thermal misalignment as indicated by L.

Finally in FIGS. 9A and 9B an alternative embodiment of an optical board connector assembly 8 is shown. In this embodiment multiple ribbon optical cables 7 are employed while using a single protruding fibre fixation part 9. The single ferrule plate 10 comprises second positioning elements 24 arranged as shown in FIG. 8C as a result of which thermal misalignment effects can be reduced.

1. Optical alignment system comprising an optical board connector with a ferrule assembly terminating a plurality of optical fibres and a circuit board comprising a cavity for at least one embedded device, said circuit board comprising first positioning elements characterized in that said circuit board comprises a plate exposing said cavity and having an accurate position with respect to said cavity and said ferrule assembly comprises second positioning elements adapted to cooperate with said first positioning elements made available by said plate to align said terminated optical fibres and said embedded device.

2. Optical alignment system according to claim 1, wherein said first positioning elements are provided as separate elements on or within said circuit board.

3. Optical alignment system according to claim 2, wherein said plate comprises holes adapted to cooperate with said first positioning elements and to position said plate with respect to said cavity.

4. Optical alignment system according to claim 1, wherein said plate comprises said first positioning means alignment pins or holes.

5. Optical alignment system according to claim 4, wherein said alignment pins protrude into said circuit board.

6. Optical alignment system according to claim 1, wherein said plurality of optical fibres constitutes a high density array and said second positioning elements comprise three alignment pins or holes positioned with respect to the centre of said array.

7. Optical alignment system according to claim 1, wherein said circuit board comprises a housing for said embedded device adapted to pre-position said optical board connector.

8. Optical alignment system according to claim 1, wherein said ferrule assembly is movably contained by said optical board connector.

9. Optical alignment system according to claim 1, wherein said ferrule assembly comprises a ferrule plate protruding from said board connector within said cavity.

10. Optical alignment system according to claim 1, wherein said plurality of optical fibres constitutes a two-dimensional array of optical fibres.

11. Optical alignment system according to claim 1, wherein said ferrule assembly comprises holes for terminating said optical fibres, said holes comprising at least one substantially straight edge.

12. Optical alignment system comprising an optical board connector with a ferrule assembly terminating a plurality of optical fibres and a circuit board comprising a cavity for at least one embedded device, said circuit board comprising first positioning elements, wherein said ferrule assembly is movably contained by said optical board connector and comprises second positioning elements adapted to cooperate with said first positioning elements to align said terminated optical fibres and said embedded device.

13. Ferrule assembly comprising second positioning elements for use in a system according to claim 1.

14. Plate adapted to make available first positioning elements for use in a system according to claim 1.

15. Method for aligning an optical board connector with terminated optical fibres and a circuit board comprising first positioning elements and a cavity for at least one embedded device comprising the steps of:
providing a plate with an opening exposing said embedded device and positioning said plate with respect to said cavity such that said first positioning elements remain available;
positioning said board connector onto said plate and aligning said optical fibres with said embedded device by having second positioning elements of said board connector cooperating with said first positioning elements.
